(19) United States
(12) Patent Application Publication
(10) Pub. No.: US 2007/0036305 A1
(43) Pub. Date: Feb. 15, 2007

(54) Service charge management apparatus, service charge management method and storage medium

(75) Inventors: Kouitirou Takahasi, Kawasaki (JP); Masaki Okuda, Kawasaki (JP); Akira Katsumata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/268,468

(22) Filed: Nov. 8, 2005

(30) Foreign Application Priority Data
Jul. 12, 2005 (JP) JP2005-203055

(51) Int. Cl. H04M 15/00

(52) U.S. Cl. 379/114.1

(57) ABSTRACT

A charge management apparatus includes a module measuring a usage quantity of an information processing device when providing a user specified by user identifying information with a service based on an program specified by program identifying information on the information processing device specified by a device identifying information, a module measuring a usage quantity of the program when providing the service, a module calculating a device charge from a unit usage charge of the information processing device referred to based on the device identifying information and from a usage quantity of the information processing device, a module calculating a program charge from a unit usage charge of the program referred to based on the program identifying information and from a usage quantity of the program, and a module calculating a service charge for providing the service from the device charge and from the program charge.

### BACKGROUND OF THE INVENTION

The invention relates to a technology of managing service charges.

There is a service for providing users with a variety of functions via a network by an application executed on a computer. Such a service is provided by a service provider called, e.g., an ASP (Application Service Provider). This category of service may include a service for printing information desired by the user (refer to, e.g., Patent document 1).

Hitherto, in the ASP, when imposing a charge on each individual user according to a usage quantity of the service by the user, this usage quantity involves using an application usage quantity calculated from a length of usage time of the application or from a usage count of the application.

On the other hand, in computer center under a main frame system as hitherto existed, in the case of imposing the charge on each user according to the usage quantity of the service by the user, the usage quantity involves using a computer usage quantity such as a length of usage time of the computer (mainly, CPU usage time) or an execution count of machine language instructions.

[Patent document 1] Japanese Patent Application Laid-Open Publication No. 2003-122538

### SUMMARY OF THE INVENTION

By the way, the computer center is unable to improve performance by exchanging all the existing computer group at the same point of time. Hence, there are many cases of having no alternative but to sequentially add high-performance computers or the latest computers. Therefore, a state occurred is that the computers different in their performance coexist in the computer center. As a result, in terms of providing the ASP service, the same application is to be executed by the computers different in their performance.

In an accounting method of charging based on the application quantity, however, in the case of providing the service in a way that gets the same application executed by the computers different in their performance, impartiality occurs between the user receiving the service through the high-performance computer and the user receiving the service through the low-performance computer. Then, there arises a problem of being unable to flexibly purchase a variety of the computers in the computer center in order to avoid such a situation.

On the other hand, when charging based on only the computer usage quantity, it follows that charging is effected irrespective of a type of the application to be executed. A development cost (or a purchase cost in the case of an externally purchased product) differs depending on the applications, and hence a problem is that a proper charge is not acquired if the type of the application is ignored.

The invention is devised in view of the problems inherent in the prior arts. Namely, it is an object of the invention to enrich assortment of information processing devices such as computers and to provide a proper accounting technology when providing a user with a program-based service by use of a plurality of information processing devices different in their performance.

The invention adopts the following means in order to solve the problems. Namely, the invention is a service charge management device comprising a module measuring a usage quantity of an information processing device when providing a user specified by user identifying information with a service based on an information processing program specified by program identifying information on the information processing device specified by a device identifying information, a module measuring a usage quantity of the information processing program when providing the service, a module calculating a device charge from a unit usage charge of the information processing device referred to based on the device identifying information and from a usage quantity of the information processing device, a module calculating a program charge from a unit usage charge of the information processing program referred to based on the program identifying information and from a usage quantity of the information processing program, and a module calculating a service charge for providing the service from the device charge and from the program charge.

According to the service charge management device, the device charge is calculated from the unit usage charge of the information processing device and from the usage quantity thereof, the program charge is calculated from the unit usage charge of the information processing program and from the usage quantity thereof, and the service charge for providing the service by use of the information processing device and the information processing program, is calculated. It is therefore possible to calculate the proper service charge even in the case of providing the service in such a way that the information processing devices different in their performance execute the information processing program, and to impose this service charge on the user.

Further, the invention may be a service charge management method by which any of the processes is executed by a computer, other device, machine, etc. Still further, the invention may also be a program making the computer, other device, machine, etc. execute any of the functions. Yet further, the invention may also be a recording medium recorded with the program, which can be read by the computer, other device, machine, etc.

According to the invention, it is possible to enrich the assortment of the information processing devices such as the computers and to impose the proper charge on the user in the case of providing the user with the program-based service by use of the plurality of information processing devices different in their performance.

### BRIEF DESCRIPTION OF THE DRAWINGS

FIG. 1 is a diagram of a system architecture of an information system according to a first embodiment of the invention,

FIG. 2 is a diagram showing a structure of an application usage charge unit cost table,

FIG. 3 is a diagram showing a structure of a computer usage charge unit cost table,

FIG. 4 is a diagram showing a structure of a usage record table,

FIG. 5 is a flowchart of a charge calculating process on an ASP control computer 1.

### DETAILED DESCRIPTION OF THE INVENTION

An information system according to a best mode (which will hereinafter be referred to as an embodiment) for carrying out the invention, will be described with reference to the drawings. A configuration of the following embodiment is an exemplification, and the invention is not limited to the configuration of the embodiment.

### Embodiment

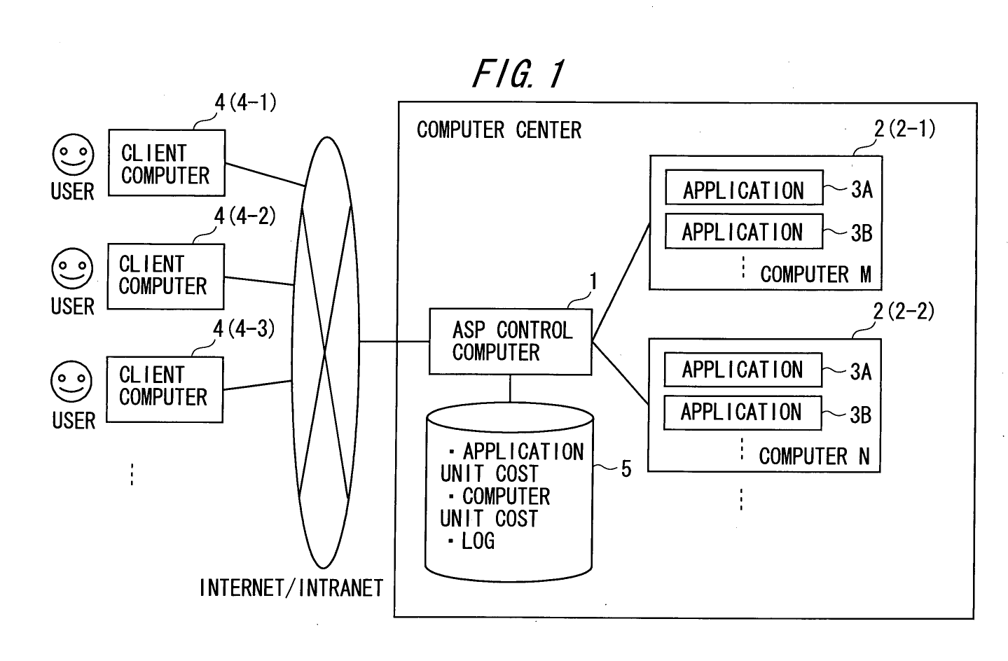

FIG. 1 is a diagram of a system architecture of the information system. This information system is configured by a computer center operated by an ASP, and client computers 4-1, 4-2, 4-3, etc. of users who access the computer center via the Internet or an Intranet. Note that the client computers 4-1 etc. are, in the case of giving a generic term thereto, called the client computer(s) 4.

The client computer 4 is a computer having a CPU, a memory, a hard disc device, a communication interface, etc. and accessible to the Internet or the Intranet. This type of computer is well known in its configuration and operation as, e.g., a personal computer, and hence its explanation is omitted.

The computer center includes an ASP control computer 1 connected to the Internet or the Intranet, and computers 2-1, 2-2, etc. for providing a variety of functions or information processing services to the users via the ASP control computer 1. Hereinafter, the computers 2-1 etc. are, in the case of giving a generic term thereto, called the computer(s) 2.

Each of the ASP control computer 1 and the computer 2 has a CPU, a memory, a hard disc device, a communication interface, etc. This type of computer is well known in its configuration and operation, and therefore its explanation is omitted. It is to be noted that the ASP control computer 1 includes a first communication interface connected to the Internet or the Intranet, and a second communication interface connected to the computers 2-1, 2-2, etc.

The ASP control computer 1 accepts an access from the user via the Internet or the Intranet. The ASP control computer 1 provides, e.g., a Web site on the Internet or the Intranet and accepts the access from the client computer 4 of the user.

In this type of Web site, a user ID (corresponding to user identifying information according to the invention) for identifying the user is set, and a designation of the function or the information processing service required by the user is accepted. Then, the ASP control computer 1 executes, on a light-load computer among the computers 2-1 etc., an application program corresponding to the function or the service in order to provide the function or the information processing service requested by the user. Then, the ASP control computer 1 transmits a result of this execution to the client computer 4 of the user. Namely, the ASP control computer 1 functions as an interface between the client computer 4 of the user and the computer 2-1 etc. of the computer center.

The computers 2-1, 2-2, etc. execute application programs 3A, 3B, etc. in accordance with an instruction of the ASP control computer 1. Then, the computers 2-1, 2-2, etc. provide, in linkage with the ASP control computer 1, the users with the variety of functions or the information processing services as (provided by) the ASP.

The ASP control computer 1 stores a database with management information for managing the computer center. The database 5 contains an application usage charge unit cost table for managing usage unit costs of the applications 2A, 2B, etc., a computer usage charge unit cost table recorded with usage unit costs of the computers 2 and a usage record table (log table) recorded with usage states (logs) of the computers 2 at the computer center.

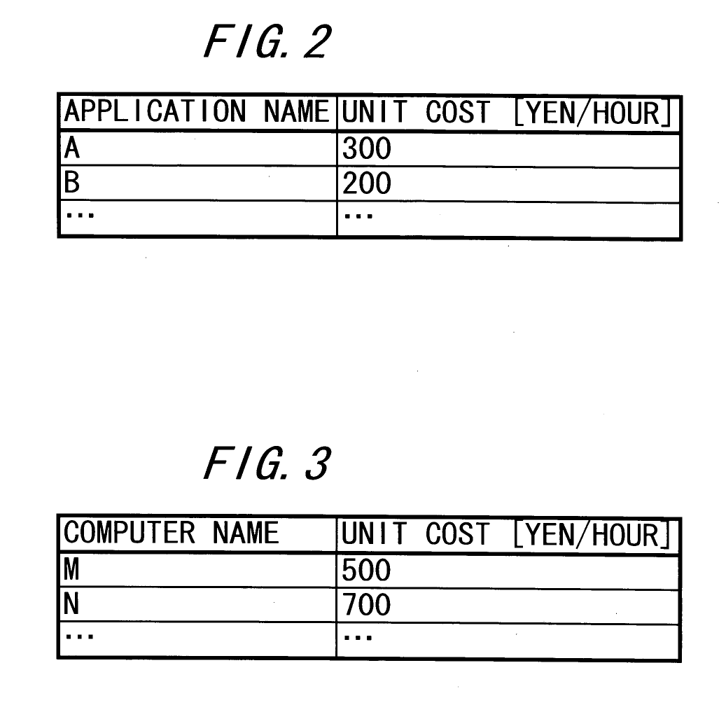

FIG. 2 shows a structure of the application usage charge unit cost table. The application usage charge unit cost table contains a field of an “application name” defined as information for identifying the application (which corresponds to program identifying information according to the invention), and a field of “unit cost” per hour of the application. Note that as the application identifying information, an identification code may be used in a way that replaces the application name or combines with the application name. The identification code may be defined in, for example, an application master. The unit cost is a charge for using the application program, for instance, per hour.

FIG. 3 shows a structure of the computer usage charge unit cost table. The computer usage charge unit cost table contains a field of “computer name” defined as information for identifying the computer 2 (which corresponds to device identifying information according to the invention) and a field of “unit cost” per hour of the computer. Note that as the information for identifying the computer 2, an identification code may be used in a way that replaces the computer name or combines with the computer name. The identification code may be defined in, for example, a computer master. Further, the computer identification code may also be a node name or a network address etc. for identifying the computer on the network. The unit cost is a charge for using the computer, for instance, per hour.

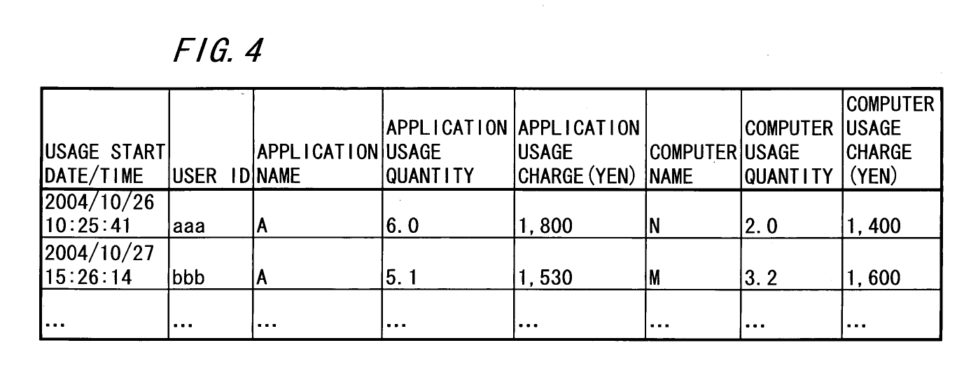

FIG. 4 shows a structure of the usage record table. The usage record table is recorded with the usage records in a way that one record about every service (every function or every information processing service provided to the user) is recorded. Each of the records in the usage record table has fields such as usage start date/time, a user ID, an application name, an application usage quantity, an application usage charge, a computer name, a computer usage quantity and a computer usage charge.

The usage start date/time is a date and time when starting the use of the computer 2 and the application programs 2A, 2B, etc. for the service associated with that record. The user ID is information for identifying the user provided with the service. The application name is a name of the application program employed for that service.

The application usage quantity is a length of time for which the application program has been used. Herein, the usage time is, for example, a length of time till the application program is unloaded since the application program was loaded into the computer 2. The ASP control computer 1 measuring this usage time corresponds to a module measuring a usage quantity of an information processing program according to the invention. The application usage charge is a charge for using the application for the service, and is obtained from a product of the application usage quantity and the unit cost.

The computer name is a name of the computer employed for the service. The computer usage quantity is a length of time for which the CPU of the computer has been employed for the service. The ASP control computer 1 measuring this CPU time corresponds to a module measuring a usage quantity of an information processing device according to the invention. The computer charge is a charge for using the computer for the service and is obtained from a product of the computer usage quantity and the unit cost.

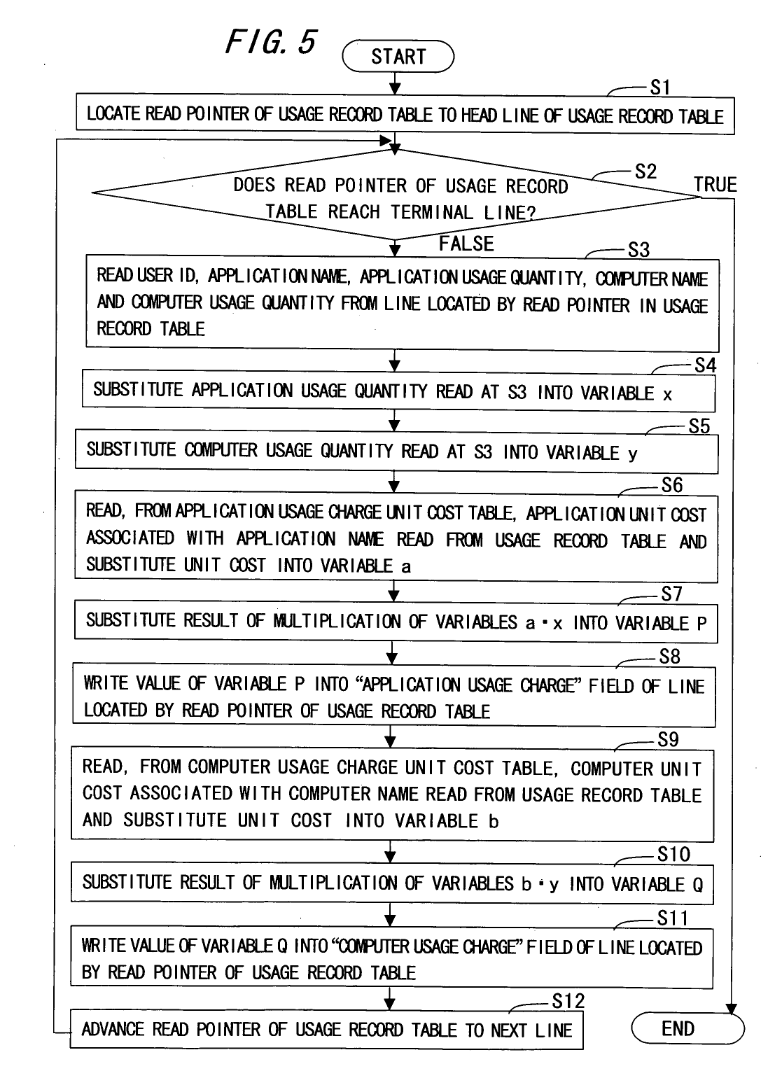

FIG. 5 shows a flowchart of a charge calculating process in the ASP control computer 1. This charge calculating process is actualized by making the ASP control computer 1 execute the program.

In this process, at first, the ASP control computer 1 locates a read pointer of the usage record table to a head line of the usage record table (which is a not-yet-processed head line with the accounting process unexecuted) (S1). Note that the usage charge table is stored on, e.g., a nonvolatile memory, a hard disc, etc. of the ASP control computer 1.

Next, the ASP control computer 1 judges whether the read pointer of the usage record table reaches a terminal line or not (S2). If the read pointer reaches the terminal line, the ASP control computer 1 finishes the process.

Whereas if the read pointer does not yet reach the terminal line, the ASP control computer 1 reads the user ID, the application name, the application usage quantity, the computer name and the computer usage quantity from the line (record) located by the read pointer of the usage record table (S3).

Next, the ASP control computer 1 substitutes the application usage quantity read from the usage record table into a variable (parameter) x (S4). The variable x is held on the memory of the ASP control computer 1. Further, the ASP control computer 1 substitutes the computer usage quantity read from the usage record table into a variable (parameter) y (S5). The variable y is held on the memory of the ASP control computer 1.

Moreover, the ASP control computer 1 reads, from the application usage charge unit cost table, the application unit cost associated with the application name read from the usage record table, and substitutes this unit cost into a variable (parameter) a (S6). Then, the. ASP control computer 1 substitutes a result of multiplication of the variable a and the variable x into a variable P (S7). The variables a and P also are held on the memory of the ASP control computer 1.

Subsequently, the ASP control computer 1 writes (enters) a value of the variable P in the “application usage charge” field in the line (record) located by the read pointer of the usage record table (S8). The ASP control computer 1 executing steps S3, S4, S6, S7 and S8 given above corresponds to a module calculating a program charge according to the invention.

Next, the ASP control computer 1 reads, from the computer usage charge unit cost table, the computer unit cost associated with the computer name read from the usage record table, and substitutes this unit cost into a variable b (S9). Then, the ASP control computer 1 substitutes a result of multiplication of the variable b and the variable x into a variable Q (S10). The variables b and Q also are held on the memory of the ASP control computer 1.

Next, the ASP control computer 1 writes (enters) a value of the variable Q in the “computer usage charge” field in the line (record) located by the read pointer of the usage record table (S11). The ASP control computer 1 executing steps S3, S5, S9, S10 and S11 given above corresponds to a module calculating a device charge according to the invention.

Then, the ASP control computer 1 advances the read pointer of the usage record table to a next line (S12). Subsequently, the ASP control computer 1 returns the control to S2.

Thus, the ASP control computer 1 calculates the application usage charge and the computer usage charge for every service per user. Then, the ASP control computer 1 charges the user for the service provided based on both of the application usage charge and the computer usage charge. The ASP control computer 1 executing this process corresponds to a module calculating a service charge according to the invention.

For example, the following accounting (methods) is available. To begin with, the unit cost is set as below.
Unit Cost in Application Usage Charge:
   Application A: 300 yen/hour;
   Application B: 200 yen/hour;
The application usage quantity shall, however, involve using the application usage time.
Unit Cost in Computer Usage Charge:
   Computer M: 500 yen/hour;
   Computer N: 700 yen/hour;
The computer usage quantity shall, however, involve using the CPU usage time.

Then, in the case of the unit costs given above, for instance, when the user executes the application A on the computer N, supposing that the application usage time is 6 hours and the CPU usage time is 2 hours, the result is:

Application Usage Charge=300 yen/hour×6 hours=1,800 yen;

Computer Usage Charge=700 yen/hour×2 hours=1,400 yen;

whereby the user is charged totally 3,200 yen.

As discussed above, according to the information system in the embodiment, the charge imposed on the user for the service provided by the ASP can be calculated in a way that reflects both of the computer usage quantity and the application usage quantity. Accordingly, even in the case of providing the service in a way that executes the plurality of application programs by employing the plurality of computers different in their performance, a demand for the proper charge can be made. Hence, even in the case of providing the service by use of the plurality of computers different in their performance without replacing the computers at the same point of time in the ASP, the proper charge can be imposed on the user.

### MODIFIED EXAMPLE

In the embodiment, simply the result of the multiplication of the unit cost and the usage quantity is set as the charge. The embodiment of the invention is not, however, limited to such a procedure. For example, if the application usage quantity becomes equal to or greater than a fixed quantity, the application usage charge may be calculated by decreasing the unit cost in the application usage charge. Namely, the application usage quantity is divided stepwise such as TA1, TA2, . . . (time), and there may be provided a table in which to set discount rates RA1, RA2, . . . in the case of an excess of the usage quantity over the time TA1, TA2 (where 0<RA1<RA2< . . . <1). Then, for instance, if the application usage quantity exceeds TA1, a×(1−RA1) may be set as a unit cost that replaces the unit cost stored in the variable a.

Similarly, the computer usage quantity is divided stepwise such as TC1, TC2, . . . (time), and there may be provided a table in which to set discount rates RC1, RC2, . . . in the case of an excess of the usage quantity over the time TC1, TC2 (where 0<RC1<RC2< . . . <1). Then, for instance, if the computer usage quantity exceeds TC1, b×(1−RC1) may be set as a unit cost that replaces the unit cost stored in the variable b.

The embodiment has exemplified the CPU time as the computer usage time. The embodiment of the invention is not, however, limited to such a procedure. For instance, as a substitute for the CPU time, an execution count of machine language instructions when providing the service to the user is counted, and a result of this execution count may also be set as the computer usage time.

<Storage Medium Readable by a Machine>

A program for making a computer and other machine and device (which will hereinafter be referred to as the computer etc.) actualize any one of the functions can be recorded on a storage medium readable by the computer etc. Then, the computer etc. is made to read and execute the program on this storage medium, whereby the function can be provided.

Herein, the storage medium readable by the computer etc. connotes a storage medium capable of accumulating information such as data, programs, etc. electrically, magnetically, optically, mechanically or by chemical action, which can be read from the computer and so on. Among these storage mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the storage mediums fixed within the computer.

<Others>

The disclosures of Japanese patent application No. JP2005-103055 filed on Jul. 12, 2005 including the specification, drawings and abstract are incorporated herein by reference.

What is claimed is:

1. A service charge management apparatus comprising:
a module measuring a usage quantity of an information processing device when providing a user specified by user identifying information with a service based on an information processing program specified by program identifying information on the information processing device specified by a device identifying information;
a module measuring a usage quantity of the information processing program when providing the service;
a module calculating a device charge from a unit usage charge of the information processing device referred to based on the device identifying information and from a usage quantity of the information processing device;
a module calculating a program charge from a unit usage charge of the information processing program referred to based on the program identifying information and from a usage quantity of the information processing program; and
a module calculating a service charge for providing the service from the device charge and from the program charge.

2. A service charge management method comprising:
measuring a usage quantity of an information processing device when a computer provides a user specified by user identifying information with a service based on an information processing program specified by program identifying information on the information processing device specified by a device identifying information;
measuring a usage quantity of the information processing program when providing the service;
calculating a device charge from a unit usage charge of the information processing device referred to based on the device identifying information and from a usage quantity of the information processing device;
calculating a program charge from a unit usage charge of the information processing program referred to based on the program identifying information and from a usage quantity of the information processing program; and
calculating a service charge for providing the service from the device charge and from the program charge.

3. A storage medium readable by a machine tangible embodying a program of instructions executable by the machine to perform method steps comprising:
measuring a usage quantity of an information processing device when a computer provides a user specified by user identifying information with a service based on an information processing program specified by program identifying information on the information processing device specified by a device identifying information;
measuring a usage quantity of the information processing program when providing the service;
calculating a device charge from a unit usage charge of the information processing device referred to based on the device identifying information and from a usage quantity of the information processing device;
calculating a program charge from a unit usage charge of the information processing program referred to based on the program identifying information and from a usage quantity of the information processing program; and
calculating a service charge for providing the service from the device charge and from the program charge.
